(19) United States
(12) Patent Application Publication
(10) Pub. No.: US 2024/0199797 A1
(43) Pub. Date: Jun. 20, 2024

(54) PET POLYESTER MATERIAL

(71) Applicant: NAN YA PLASTICS CORPORATION, TAIPEI (TW)

(72) Inventors: Te-Chao Liao, Taipei (TW); Chun-Che Tsao, Taipei (TW); Wen-Jui Cheng, Taipei (TW); Yueh-Shin Liu, Taipei (TW)

(73) Assignee: NAN YA PLASTICS CORPORATION, TAIPEI (TW)

(21) Appl. No.: 18/188,477

(22) Filed: Mar. 23, 2023

(30) Foreign Application Priority Data
Dec. 14, 2022 (TW) 111147912

(51) Int. Cl. C08G 63/183; C08J 5/04; C08K 3/30; C08K 3/36; C08K 5/098; C08K 7/14; C08L 67/03

(52) U.S. Cl. CPC C08G 63/183; C08J 5/043; C08K 3/30; C08K 3/36; C08K 5/098; C08K 7/14; C08L 67/03; C08J 2367/03; C08K 2003/3063; C08K 2201/011; C08L 2203/30; C08L 2205/025; C08L 2207/20

(57) ABSTRACT

A PET polyester material includes polyethylene terephthalate (PET) resin, nucleating agent, lubricant agent, antioxidant, and inorganic reinforcing material. The inorganic reinforcing material comprises talc, calcium sulfate whisker, magnesium sulfate whisker, glass fiber or a combination thereof. The inorganic reinforcing material is added in an amount of 5% by weight to 15% by weight based on a total weight of the PET polyester material.

### CROSS-REFERENCE TO RELATED APPLICATION

This application claims the priority benefit of Taiwan application serial no. 111147912, filed on Dec. 14, 2022. The entirety of the above-mentioned patent application is hereby incorporated by reference herein and made a part of this specification.

### BACKGROUND

### Technical Field

The disclosure relates to a polyester material, and particularly relates to a PET polyester material that may be injection molded at low temperature and heat resistant.

### Description of Related Art

Net zero emission of carbon is the direction and goal of the recent efforts of various countries and brands. It makes the market gradually to be orientated toward the trend of circular economy and plastic recycling. Under such trend of the market, the use of one single material for products and the introduction of recycled materials are important goals for future development. The introduction of recycled materials means to introduce environmentally friendly recycled materials on the premise that mechanical properties and processability are not affected, which helps to achieve the goal of reducing plastics and saving energy globally. One single material of the product means to unify the material used in products, so that the products may be directly recycled when they reach the service life, avoiding poor recyclability caused by the mixing of different materials.

Taking clothes and backpacks as an example, the fabrics of clothes and backpacks are usually made of a polyester material (for example, polyethylene terephthalate (PET)), but the buckles and zippers are usually made of a polyoxymethylene (POM) material or a nylon material. After these products are discarded, they can only be incinerated or manually dismantled in order to be recycled. Products such as curtains face the same issue.

### SUMMARY

In order to enable the use of one single material in products, the buckles or peripheral accessories made of a POM material or a nylon material, for example, may be made with a PET material instead. However, unmodified PET materials have a slow crystallization rate, insufficient heat resistance, and a large friction coefficient, as such unmodified PET materials may not be easily used for replacing the injection products made of POM and nylon. In addition, the heat resistance of the PET materials needs to be improved by crystallization. The present PET materials need high mold temperature (higher than 120° C.) or secondary high-temperature crystallization process to achieve crystallization and heat resistance. As such, the process is limited and energy-consuming, and has a long molding cycle.

The disclosure provides a PET polyester material, which may be injection molded at low temperature and has an advantage of high level of heat resistance.

The PET polyester material according to the disclosure comprises a polyethylene terephthalate (PET) resin, a nucleating agent, a lubricant, an antioxidant, and an inorganic reinforcing material. The inorganic reinforcing material comprises talc, calcium sulfate whisker, magnesium sulfate whisker, glass fiber or a combination thereof. The inorganic reinforcing material is added in an amount of 5% by weight to 15% by weight based on a total weight of the above-mentioned PET polyester material.

In an embodiment of the disclosure, the above-mentioned inorganic reinforcing material is added in an amount of 10% by weight to 15% by weight based on a total weight of the above-mentioned PET polyester material.

In an embodiment of the disclosure, the above-mentioned PET resin comprises a virgin resin, a post consumer recycled resin, or a combination thereof. The above-mentioned PET resin has an intrinsic viscosity (IV) of 0.60 to 0.92.

In an embodiment of the disclosure, the above-mentioned PET resin is added in an amount of 72% by weight to 89% by weight based on a total weight of the above-mentioned PET polyester material.

In an embodiment of the disclosure, the above-mentioned nucleating agent comprises organic nucleating agent, inorganic nucleating agent, or a combination thereof. The above-mentioned nucleating agent is added in an amount of 2% by weight to 10% by weight based on a total weight of the above-mentioned PET polyester material.

In an embodiment of the disclosure, the above-mentioned organic nucleating agent comprises organic sodium salts. The organic sodium salts comprise sodium benzoate, sodium stearate, sodium salt of montanic acids, or sodium salt of ethylene-methyl methacrylate copolymer (EMMA-Na).

In an embodiment of the disclosure, the above-mentioned inorganic nucleating agent comprises inorganic micro-nano powder. The inorganic micro-nano powder comprises talc, titanium dioxide, silicon dioxide, or calcium carbonate.

In an embodiment of the disclosure, the above-mentioned lubricant comprises stearates, polyethylene wax, siloxane modifier, or a fluorine-based resin. The above-mentioned lubricant is added in an amount of 0.1% by weight to 2% by weight based on a total weight of the above-mentioned PET polyester material.

In an embodiment of the disclosure, the above-mentioned antioxidant comprises a hindered phenolic antioxidant, a phenolic antioxidant, a mixed antioxidant, a phosphite-based antioxidant, a complex antioxidant, or a combination thereof. The above-mentioned antioxidant is added in an amount of 0.1% by weight to 1% by weight based on a total weight of the above-mentioned PET polyester material.

In an embodiment of the disclosure, the above-mentioned PET polyester material is injection molded at a mold temperature of 80° C. to 90° C.

Based on the above, the PET polyester material of the disclosure is modified by introducing the nucleating agent, the lubricant, the antioxidant, and the inorganic reinforcing material into the PET resin. The nucleating agent and the inorganic reinforcing material may increase the crystallization rate and effectively improves the heat resistance of the PET material. The lubricant may reduce the surface friction coefficient of the PET material to improve the wear resistance of the products. The antioxidant may improve the heat resistance and processability of the PET material. Accordingly, the PET polyester material of the disclosure may effectively improve low crystallization and insufficient heat resistance of the existing PET material, to achieve a PET polyester material that may be injection molded at low temperature and heat resistant.

### DETAILED DESCRIPTION OF DISCLOSED EMBODIMENTS

Hereinafter, embodiments of the disclosure will be described in detail. However, these embodiments are exemplary, and the disclosure is not limited thereto.

In this specification, a range represented by “one numerical value to another numerical value” is a general representation that avoids listing all the numerical values within the range. Accordingly, the recitation of a particular numerical range covers any numerical value within that numerical range as well as a smaller numerical range defined by any numerical value within that numerical range, as if the above-mentioned any numerical value and smaller numerical range are specified in this specification.

According to the disclosure, the PET polyester material includes a polyethylene terephthalate (PET) resin, a nucleating agent, a lubricant, an antioxidant, and an inorganic reinforcing material. Specifically, the PET polyester material is modified by introducing appropriate amounts of the nucleating agent, the lubricant, the antioxidant, and the inorganic reinforcing material into the PET resin. In some embodiments, compared to an unmodified PET polyester material which need to have high mold temperature (higher than 120° C.) or secondary crystallization process to achieve a property of heat resistant of injection molding products, the modified PET polyester material (that is, the PET polyester material of the disclosure) has better heat resistance, so that injection molding at low mold temperature (80° C. to 90° C.) may be feasible. Therefore, it may be applied to products that require thermal resistance, such as zippers, buckles, curtain parts, or cutleries, but not limited thereto. Hereinafter, the above-mentioned various components will be described in detail.

### Polyethylene Terephthalate (PET) Resin

In this embodiment, the PET resin may include a virgin resin, a post consumer recycled resin (PCR resin), or a combination thereof. The sources of the PCR resin may include recycled resin from bottles, recycled resin from film materials, recycled resin from fabrics, industrially recycled environmentally friendly recycled polyester resin (such as release films), or other PET products, in order to enable the introduction of recycled materials, but not limited thereto.

Specifically, based on the total weight of the PET polyester material, the PET resin may be added in an amount of, for example, 72% by weight to 89% by weight, but not limited thereto. In an embodiment of the disclosure, the intrinsic viscosity (IV) of the PET resin used may be, for example, 0.60 to 0.92, preferably 0.68 to 0.84, but not limited thereto. When the intrinsic viscosity of the PET resin is less than 0.60, the impact strength of the PET resin may be too low, and as a result, the injection molded product may have insufficient strength and embrittlement. When the intrinsic viscosity of the PET resin is greater than 0.92, the viscosity of the PET resin may be too high, resulting poor fluidity, and the PET resin may not be suitable for injection molding.

### Nucleating Agent

In this embodiment, the nucleating agent may include an organic nucleating agent, an inorganic nucleating agent, or a blend thereof. The organic nucleating agent may include organic sodium salts, such as sodium benzoate, sodium stearate, sodium salt of montanic acids, or sodium salt of ethylene-methyl methacrylate copolymer (EMAA-Na), but not limited thereto. The inorganic nucleating agent may include inorganic micro-nano powder, such as talc (particle size (D50) less than 2 microns), titanium dioxide, silicon dioxide, or calcium carbonate, but not limited thereto. The introduction of the nucleating agent may increase the crystallization rate, and effectively improve the shrinkage rate of the PET material, thereby improving the processability. In this embodiment, based on the total weight of the PET polyester material, the nucleating agent is added in an amount of, for example, 2% by weight to 10% by weight, preferably 5% by weight to 8% by weight, but not limited thereto. When the amount of the nucleating agent added is less than 2% by weight, the effect of increasing the crystallization rate of PET may not be significant. When the amount of the nucleating agent added is greater than 10% by weight, the increase of the nucleation rate may have reached the limit, and the excessive addition of the nucleating agent may increase the cost and embrittle the material. Further, when the amount of the nucleating agent added is 5% by weight to 8% by weight, the material may have relatively balanced mechanical properties (impact strength) and crystallization rate.

### Lubricant

In this embodiment, the lubricant may include stearates (for example, zinc stearate, sodium stearate, calcium stearate, etc.), polyethylene wax, siloxane modifier (for example, siloxane), or a fluorine-based resin (for example, PEFE). The introduction of the lubricant may reduce the surface friction coefficient of the PET material, thereby improve the wear resistance of the product. In this embodiment, based on the total weight of the PET polyester material, the lubricant is added in an amount of, for example, 0.1% by weight to 2% by weight, preferably 0.5% by weight to 1% by weight, but not limited thereto. When the amount of the lubricant added is less than 0.1% by weight, the effect of reducing the friction coefficient may be poor, and the effect of improving the wear resistance of PET may not be significant. When the amount of the lubricant added is more than 2% by weight, the material may have excessively high fluidity, and as a result, flashing is likely to occur during injection, and the conditions are difficult to control. Furthermore, excessive addition of the lubricant may also cause embrittlement of the material and reduce the impact strength.

### Antioxidant

In this embodiment, the antioxidant may include hindered phenolic antioxidants (for example, AO-1010, AO-1076, AO-1315, etc.), mixed antioxidants (for example, B225, B215, B220, B911, etc.), phosphite-based antioxidants (for example, AO-168, AO-618, TNPP, etc.), complex antioxidants, or a combination thereof. The antioxidant may improve the heat resistance and processability of the material. In this embodiment, based on the total weight of the PET polyester material, the antioxidant is added in an amount of, for example, 0.1% by weight to 1% by weight, preferably 0.3% by weight to 0.6% by weight, but not limited thereto. When the amount of the antioxidant added is less than 0.1% by weight, the effect of improving the heat resistance of the PET material during high temperature processing is not significantly improved, and the material is prone to yellowing. When the amount of the antioxidant added is more than 1% by weight, the effect of improvement may have reached the limit. Moreover, excessive addition of the antioxidant may lead to an increase in cost.

### Inorganic Reinforcing Material

In this embodiment, the inorganic reinforcing material may include talc (particle size (D50) more than 2 microns), calcium sulfate whisker, magnesium sulfate whisker, glass fiber or a blend thereof, but not limited thereto. The introduction of the inorganic reinforcing material may increase the crystallization rate, and effectively improve the heat resistance of the PET material, thereby improve the processability. In this embodiment, based on the total weight of the PET polyester material, the inorganic reinforcing material is added in an amount of, for example, 5% by weight to 15% by weight, preferably 10% by weight to 15% by weight, but not limited thereto. When the amount of the inorganic reinforcing material added is less than 5% by weight, the effect of increasing the crystallization rate of PET may not be significant. When the amount of the inorganic reinforcing material added is greater than 15% by weight, the increase of the nucleation rate and crystallization rate may have reached the limit. Further, when the amount of the inorganic reinforcing material added is 10% by weight to 15% by weight, the material may have relatively balanced mechanical properties and have an advantage of heat resistance in injection molding at low temperature.

In the embodiment of the disclosure, a process of modifying the PET polyester material may include the following steps, but not limited thereto. First, the PET resin, the nucleating agent, the antioxidant, and the lubricant are added into an extruder at a main feed temperature of 230° ° C. to 250° C., and the inorganic reinforcing material is added by side feed into an extruder at a temperature of 250° C. to 275° ° C. The resin material is melted in a melting stage at a temperature of 260° ° C. to 280° ° C. of the screw, and is fully kneaded with the modifiers such as the nucleating agent, the antioxidant, the lubricant, and the inorganic reinforcing material. Then, at a vacuum temperature of 245° C. to 265° C., the water vapor and low molecular oligomers are removed in a vacuum and low-pressure manner, thereby producing the PET polyester material of the disclosure.

After forming the PET polyester material, processing method such as a process of injection molding may be applied to acquire final products. In some embodiments, process the PET polyester material of the disclosure into a final product of PET polyester may include the following procedures but not limited thereto. First, dry the PET polyester material of the disclosure at 140° ° C. to 160° C. for 4 hours to remove the moistures within, as such, processability of injection molding of the material, and mechanical properties of final products are ensured. Then, put the dried PET polyester material in an injection machine at a temperature of 250° C. to 285° C. of the screw to perform injection molding, and control a mold temperature at a temperature of 80° ° C. to 90° ° C. So far, a PET polyester final product is finalized.

Hereinafter, the above-mentioned PET polyester material of the disclosure will be described in detail with reference to experimental examples. However, the following experimental examples are not intended to limit the disclosure.

### Experimental Example

In order to prove that the PET polyester material according to the disclosure has excellent mechanical properties and thus has good wear resistance, the following experimental example was carried out.

### Test Sample

The test samples were a POM material (Reference Example), a unmodified PET material (Comparative Example 1), nucleating agent-modified PET material without inorganic reinforcing material (Comparative Example 2), and nucleating agent-modified PET material with inorganic reinforcing material (Example, that is the PET polyester material of the disclosure). The POM material was Duracon M90 from POLYPLASTICS CO., LTD. The unmodified PET material was recycled pellets of plastic bottles produced by Nan Ya Plastics Corporation, type number 380R. The composition of nucleating agent-modified PET material without inorganic reinforcing material includes 380R, wherein a nucleating agent (organic nucleating agent and inorganic nucleating agent, the ratio of organic nucleating agent and inorganic nucleating agent is 1:1, an amount of the nucleating agent added is 5% by weight), a lubricant (stearates, an amount of the lubricant added is 0.5% by weight), and an antioxidant (mixed antioxidant B225, an amount of the antioxidant added is 0.5% by weight) are added. The composition of nucleating agent-modified PET material with inorganic reinforcing material includes 380R, wherein a nucleating agent (organic nucleating agent and inorganic nucleating agent, the ratio of organic nucleating agent and inorganic nucleating agent is 1:1, an amount of the nucleating agent added is 8% by weight), a lubricant (stearates, an amount of the lubricant added is 0.5% by weight), an antioxidant (mixed antioxidant B225, an amount of the antioxidant added is 0.5% by weight), and an inorganic reinforcing material (glass fiber, an amount of the inorganic reinforcing material added is 15% by weight) are added. Please refer to the above description for the method of producing the PET polyester material.

### Test Method

Impact strength: The test was performed according to ASTM D256 standard. The obtained value (kg-cm/cm) indicates the total energy that the test sample can withstand when the test sample breaks. A greater value indicates that the test sample can withstand greater impact strength (or the resistance strength of the test sample).

Tensile strength: The test was performed according to ASTM D638 standard. The obtained value indicates the total energy that the test sample can withstand against tensile deformation. A greater value indicates that the test sample can withstand greater tensile strength.

Flexural strength: The test was performed according to ASTM D790 standard. The obtained value indicates the ability of the test sample to resist flexural deformation. A greater value indicates that the test sample can withstand greater flexural strength.

Flexural modulus: The test was performed according to ASTM D790 standard. The obtained value indicates the total energy that the test sample can withstand against flexural deformation. A greater value indicates that the test sample has greater rigidity.

Heat resistance: The test was performed according to ASTM D468 standard. The obtained value indicates the ability of the test sample to resist heat deformation the initial temperature at which the material begins to crystallize. A greater value indicates that the material has a higher heat resistance.

Dynamic/Static friction coefficient: The test was performed according to ASTM D1894 standard. The friction coefficient indicates the ratio of the frictional force between two solid surfaces to the normal pressure. A greater friction coefficient indicates that an object receives greater resistance when it slides.

Wear loss weight: H-22 wheel, load 1 kg, 2000 times. The initial weight of the sample was measured first, and then the H-22 wheel with a load of 1 kg was used to repeatedly roll on the sample for 2000 times to measure the remaining weight of the sample. The difference between the initial weight and the remaining weight is the wear loss weight of the sample. A smaller value indicates greater wear resistance.

### Result

Refer to the following Table 1. According to the analysis of heat resistance, compared to the unmodified PET material (Comparative Example 1) and the nucleating agent-modified PET material without inorganic reinforcing material (Comparative Example 2), at a mold temperature of 90° C., the PET polyester material of the disclosure (Example) reaching a heat resistant temperature of 92° C., which is better than the unmodified PET material (Comparative Example 1) which reaches a heat resistant temperature of 65° C. and the nucleating agent-modified PET material without inorganic reinforcing material (Comparative Example 2) which reaches a heat resistant temperature of 70° C. At a mold temperature of 140° ° C., the PET polyester material of the disclosure (Example) reaches a heat resistant temperature of 153° C., which is better than the nucleating agent-modified PET material without inorganic reinforcing material (Comparative Example 2) reaching a heat resistant temperature of 102° C. Whereas the unmodified PET material (Comparative Example 1) was unable to be processed due to the material sticks to the mold when processed at a mold temperature of 140° C. The above results show that by introducing the inorganic reinforcing material, the PET polyester material of the disclosure (Example) may be processed at low mold temperature (mold temperature at 90° C.) and have good heat resistance.

In addition, according to the analysis of mechanical properties, compared to the unmodified PET material (Comparative Example 1) and the nucleating agent-modified PET material without inorganic reinforcing material (Comparative Example 2), the PET polyester material of the disclosure (Example) has better tensile strength, flexural strength, and flexural modulus. The results represent that the PET polyester material of the disclosure is more beneficial to be applied in products requiring resistance to flexural deformation and tensile, such as zippers and curtain parts.

TABLE 1

| | | | | Comparative | |
|---|---|---|---|---|---|
| | | | | Example 2 | Example |
| | | | | nucleating agent- | nucleating |
| | | | Comparative | modified PET | agent-modified |
| | | Reference | Example 1 | material without | PET material |
| | | Example | Unmodified | inorganic | with inorganic |
| | | POM | PET | reinforcing | reinforcing |
| | | material | material | material | material |
| Mechanical | Impact | 4.9 | 3.8 | 3.6 | 4.0 |
| properties | strength | | | | |
| | (kg- | | | | |
| | cm/cm) | | | | |
| | Tensile | 63.0 | 58.7 | 63.8 | 66.8 |
| | strength | | | | |
| | (MPa) | | | | |
| | Flexural | 88.0 | 86.8 | 96.2 | 99.1 |
| | strength | | | | |
| | (MPa) | | | | |
| | Flexural | 2550 | 2350 | 2650 | 3160 |
| | modulus | | | | |
| | (MPa) | | | | |

| | | | | |
|---|---|---|---|---|
| Heat-resistance (mold | 100 | 65 | 70 | 92 |
| temperature 90° C.) | | | | |
| Heat-resistance (mold | — | Not able to | 102 | 153 |
| temperature 140° C.) | | be processed | | |
| Static/Dynamic friction | 0.37/0.32 | 0.48/0.40 | 0.40/0.34 | 0.41/0.35 |
| coefficient | | | | |
| Wear loss amount (mg) | 444.6 | 368.4 | 298.6 | 306.2 |

To sum up, the PET polyester material of the disclosure is modified by introducing the nucleating agent, the lubricant, the antioxidant, and inorganic reinforcing material into the PET resin. The nucleating agent and inorganic reinforcing material may increase the crystallization rate and effectively improve the heat resistance of the PET material. The lubricant may reduce the surface friction coefficient of the PET material to improve the wear resistance of the product. The antioxidant may improve the heat resistance and processability of the PET material. Accordingly, the PET polyester material of the disclosure may effectively improve the problems in slow crystallization rate and insufficient heat resistance of the existing PET material and achieve the PET polyester material that may be injection molded at low temperature and has a high level of heat resistance. So that the PET polyester material of the disclosure may be applied in products requiring thermal resistance, such as zippers, buckles, curtain parts, or cutleries, enable the goal of use of one single material.

Although the disclosure has been described with reference to the embodiments above, the embodiments are not intended to limit the disclosure. People having ordinary knowledge in the art can make changes and modifications without departing from the spirit and scope of the disclosure. Therefore, the scope of protection of the disclosure should be defined by the following claims.

What is claimed is:

1. A PET polyester material, comprising:
a polyethylene terephthalate (PET) resin;
a nucleating agent;
a lubricant;
an antioxidant; and
an inorganic reinforcing material, comprising talc, calcium sulfate whisker, magnesium sulfate whisker, glass fiber or a combination thereof,
wherein the inorganic reinforcing material is added in an amount of 5% by weight to 15% by weight based on a total weight of the PET polyester material.

2. The PET polyester material according to claim 1, wherein the inorganic reinforcing material is added in an amount of 10% by weight to 15% by weight based on a total weight of the PET polyester material.

3. The PET polyester material according to claim 1, wherein the PET resin comprises a virgin resin, a post consumer recycled resin, or a combination thereof; and
the PET resin has an intrinsic viscosity of 0.60 to 0.92.

4. The PET polyester material according to claim 1, wherein the PET resin is added in an amount of 72% by weight to 89% by weight based on a total weight of the PET polyester material.

5. The PET polyester material according to claim 1, wherein the nucleating agent comprises organic nucleating agent, inorganic nucleating agent, or a combination thereof; and
the nucleating agent is added in an amount of 2% by weight to 10% by weight based on a total weight of the PET polyester material.

6. The PET polyester material according to claim 5, wherein the organic nucleating agent comprises organic sodium salts, and
the organic sodium salts comprise sodium benzoate, sodium stearate, sodium salt of montanic acids, or sodium salt of ethylene-methyl methacrylate copolymer.

7. The PET polyester material according to claim 5, wherein the inorganic nucleating agent comprises inorganic micro-nano powder, and
the inorganic micro-nano powder comprises talc, titanium dioxide, silicon dioxide, or calcium carbonate.

8. The PET polyester material according to claim 1, wherein the lubricant comprises stearates, polyethylene wax, siloxane modifier, or a fluorine-based resin, and
the lubricant is added in an amount of 0.1% by weight to 2% by weight based on a total weight of the PET polyester material.

9. The PET polyester material according to claim 1, wherein the antioxidant comprises a hindered phenolic antioxidant, a phenolic antioxidant, a mixed antioxidant, a phosphite-based antioxidant, a complex antioxidant, or a combination thereof, and
the antioxidant is added in an amount of 0.1% by weight to 1% by weight based on a total weight of the PET polyester material.

10. The PET polyester material according to claim 1, wherein the PET polyester material is injection molded at a mold temperature of 80° C. to 90° C.
